(19) United States
(12) Patent Application Publication
(10) Pub. No.: US 2005/0217501 A1
(43) Pub. Date: Oct. 6, 2005

(54) Bearing tray of a kitchen appliance

(75) Inventors: Guido Babucke, Schloss Holte-Stukenbrock (DE); Peter Jahrling, Bunde (DE)

Correspondence Address: BARNES & THORNBURG, 750-17TH STREET NW, SUITE 900, WASHINGTON, DC, 20006, US

(73) Assignee: Paul Hettich GmbH & Co. KG

(21) Appl. No.: 11/095,499

(22) Filed: Apr. 1, 2005

(30) Foreign Application Priority Data
Apr. 2, 2004 (DE) 20 2004 005 475.2

(51) Int. Cl. A47J 27/62

(52) U.S. Cl. 99/450

(57) ABSTRACT

A support tray for a kitchen appliance having a rectangular tray and guiding devices at each mutually opposite lateral edges of the tray, the sliding devices include having a running rail connected to the tray and a guiding rail for mounting the support tray to support rods of a supporting grids in the side wall areas of the kitchen appliance. The guide rail are configured to be coupled and secured, in a rearward end area, against a lifting-off from the supporting rods when coupled thereto and to be form-lockingly secured, in a forward end area, against a displacement in the longitudinal direction of the supporting rods.

### BACKGROUND AND SUMMARY OF INVENTION

The present invention relates to a support tray of a kitchen appliance, such as a baking oven, a refrigerator, a microwave oven or the like, the support tray having a rectangular base area.

Support trays of the above-mentioned type are known in many different constructions.

Support trays of the type involved here are used, for example, in baking ovens or microwave ovens, for receiving goods to be cooked or baked in corresponding molds or foils, In the case of refrigerators, products to be cooled or frozen are deposited on corresponding support trays.

In principle, it should be possible to place support trays at different levels in a baking oven, a refrigerator, a microwave oven or the like. Furthermore, it is desirable to be able to pull such support trays at least partially out of the above-mentioned appliances in order to be able to, for example, treat goods to be cooked or baked or to test the cooking condition. In the case of refrigerators, a support tray, which can be at least partially pulled out of the refrigerator facilitates the removal of products which are situated in the rear of the tray in the pushed-in condition.

For cleaning purposes of the support tray itself as well as for facilitating the cleaning of an interior of a baking oven, a microwave oven or a refrigerator, it is also advantageous for support trays to be completely removable from the corresponding appliances. When needed again, it should then also be possible to push the support tray, without any problem, back into its effective position in a corresponding appliance.

It is an object of the present invention to create a support tray of the above-mentioned type which can easily and without any problem be placed in a kitchen appliance and be removed therefrom and which, without the risk of a tipping, can be pulled relatively far out of a kitchen appliance.

This and other objects are achieved in that, at its mutually opposite lateral edges, the support tray is connected with running rails of guiding devices which further includes guiding rails which can be pushed onto supporting rods of supporting grids in the side wall areas of the kitchen appliance the guiding rails. In their rearward end area, the support trays is secured against a lifting-off from the supporting rods and, in the forward end area, are form-lockingly secured against a displacement in the longitudinal direction of the supporting rods.

Thus, by means of its lateral guiding devices, a support tray can be form-lockingly fixed to the supporting rods of supporting grids of a kitchen appliance such that a complete pulling-out of the support tray in the longitudinal direction of the guiding devices is not possible and a tipping of the rearward end area is prevented just as securely. This means that the support tray is pulled out corresponding to the maximal pull-out length of the guiding devices and is also secured in the loaded condition. This considerably facilitates the use of the support tray.

The guiding rails of the guiding devices are fixed on the appliance side and a pulling-out of the support tray can take place only corresponding to the maximal pull-out length of the guiding devices. The support tray remains connected with the guiding device as a whole also in the maximally pulled-out condition. A separating of the support tray from the kitchen appliance is therefore not possible by the pulling-out along the guiding devices.

If, in contrast, the support tray is to be removed from a kitchen appliance, it is first necessary to disconnect the guiding devices from the supporting grids. This can take place only by an intentional manipulation.

To this extent, the present system facilitates the handling of the support tray while the protection against possible faulty operations is considerably increased.

These and other aspects of the present disclosure will become apparent from the following detailed description of the disclosure, when considered in conjunction with accompanying drawings.

### BRIEF DESCRIPTION FO THE DRAWINGS

FIG. 1 is a perspective representation of a support tray according to the present disclosure and two supporting grids for receiving the support tray;

FIG. 2 is a side view of a guiding device in a retracted condition in the direction of the arrow II in FIG. 1;

FIG. 3 is a view corresponding to FIG. 2 in the pulled out or extended condition of the guiding device;

FIGS. 4a to 4d are various views of a holder for coupling a support tray with the supporting grids in the forward area;

FIGS. 5a to 5d are various views of a rearward holding device for coupling the support tray with the supporting grids in the rearward area;

FIG. 6 is a perspective partial bottom view in the direction of the arrow VI in FIG. 1 wherein a support tray is attached to a supporting grid but not yet finally mounted;

FIG. 7 is a sectional view according to Line VII-VII in FIG. 2;

FIG. 8 is a perspective partial bottom view corresponding to FIG. 6 when the support tray is completely inserted;

FIGS. 9 and 10 are different views of a forward holder according to another embodiment;

FIG. 11 is a perspective view corresponding to FIG. 1 of the support tray attached to the supporting grids;

FIG. 12 is a perspective partial view of a supporting grid with a guiding device of a support tray not illustrated in detail, which guiding device is coupled to the supporting grid;

FIGS. 13a to 13d are different views of a forward holder according to another embodiment;

FIGS. 14a to 14d are different views of a rearward holding device according to another embodiment;

FIG. 15 is a perspective partial bottom view essentially corresponding to FIG. 6 when attaching a support tray with a rearward holding device according to FIGS. 14a to 14d;

FIG. 16 is a sectional view of a support tray with forward holders according to FIGS. 13a to 13d, which essentially corresponds to FIG. 7.

### DETAILED DESCRIPTION OF THE EMBODIMENTS

In the drawings, the reference number 1, in each case, indicates a support tray of a kitchen appliance as a whole which can be fixed to two mutually opposite supporting grids 2, but can also be removed again from these supporting grids 2 without any problem.

In the illustrated embodiment, the support tray 1 is constructed as a depositing grating and is used, for example, in a baking oven or a microwave oven or a refrigerator.

Deviating therefrom, such a support tray 1 can also have a closed tray surface.

The supporting grids 2 have a plurality of supporting rods 2a extending parallel to one another and are arranged in the side wall area of a baking oven or an other kitchen appliance which is not shown in detail. For further considerations, these supporting grids 2 may therefore be considered to be stationary within a kitchen appliance.

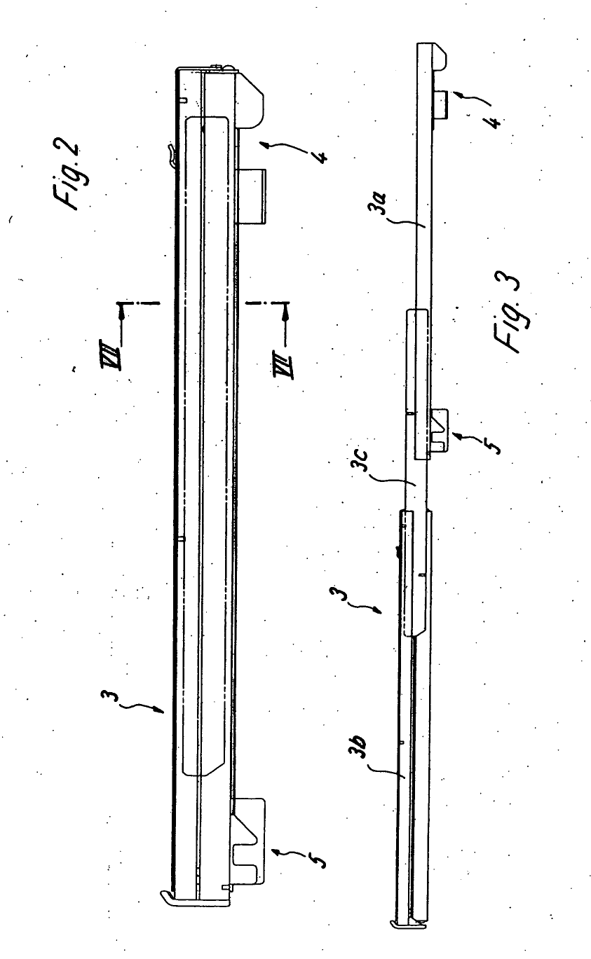

The support tray 1, which has a rectangular base area or tray 1a is equipped with guiding devices 3 at its two mutually opposite lateral edges. The guiding devices 3 are preferably constructed as telescopic guides, as illustrated in FIGS. 2 and 3. However, the guiding devices 3 at least have a guiding rail 3a and a running rail 3b. In order to implement a telescopic rail, a transition piece 3c is provided between the guiding rail 3a and the running rail 3b.

The support tray 1 is fixedly connected with the running rails 3b of the guiding devices 3. The connection may be a releasable connection or an unreleasable connection.

In their respective rearward end area, the guiding rails 3a of the guiding devices 3 are equipped with rearward holding devices 4, and in their respective forward area, are equipped with forward holders 5. The purpose is these couplers with 4 and 5 are to connect or couple these guiding rails 3a with the supporting rods 2a of the supporting grids 2 such that a lifting-off or tipping of the support tray 1 with respect to the supporting rods 2a in the rear area is prevented and, in the forward area, a protection against a displacement in the longitudinal direction of the supporting rods 2a is achieved.

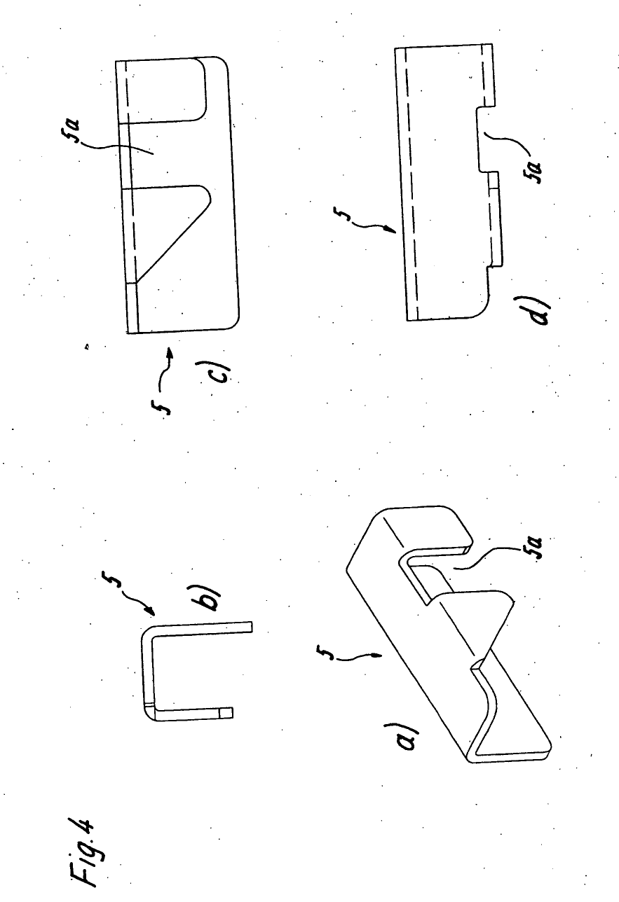

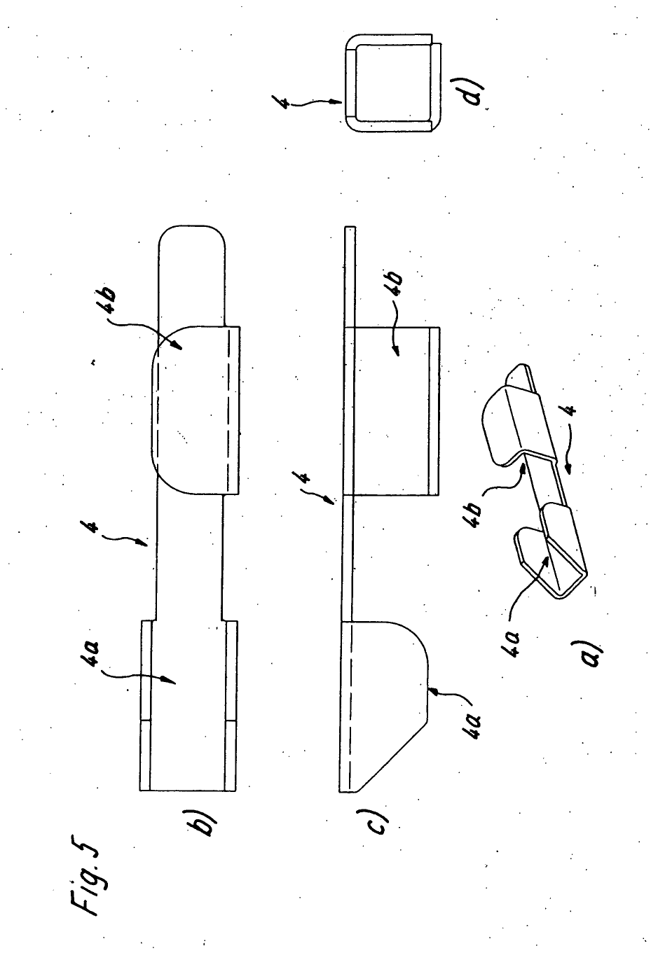

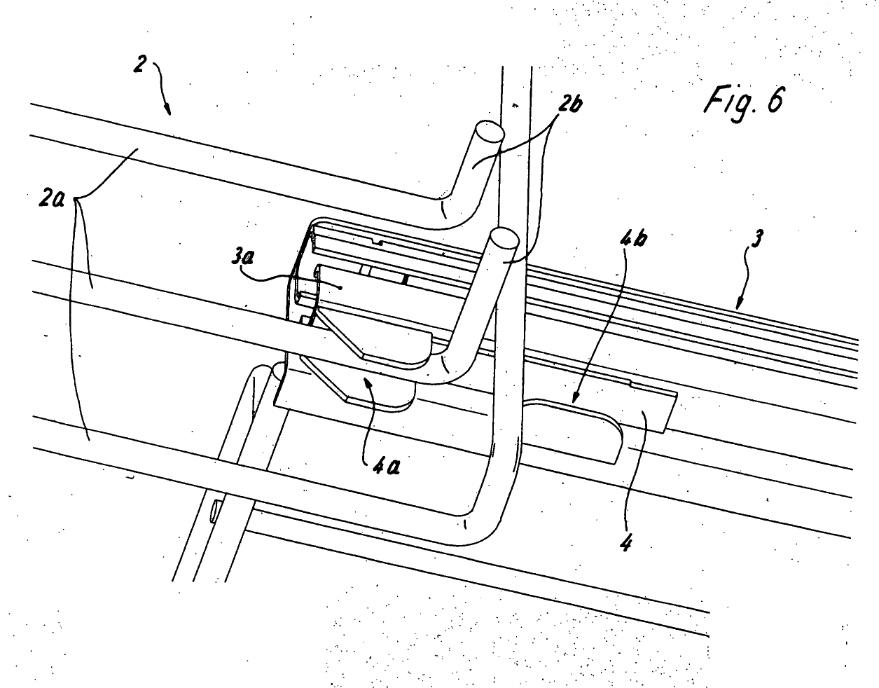

This is ensured by the design of the rearward holding devices 4 and the forward holder 5 respectively, one embodiment which are illustrated in detail in FIGS. 5a to 5d and 4a to 4d respectively.

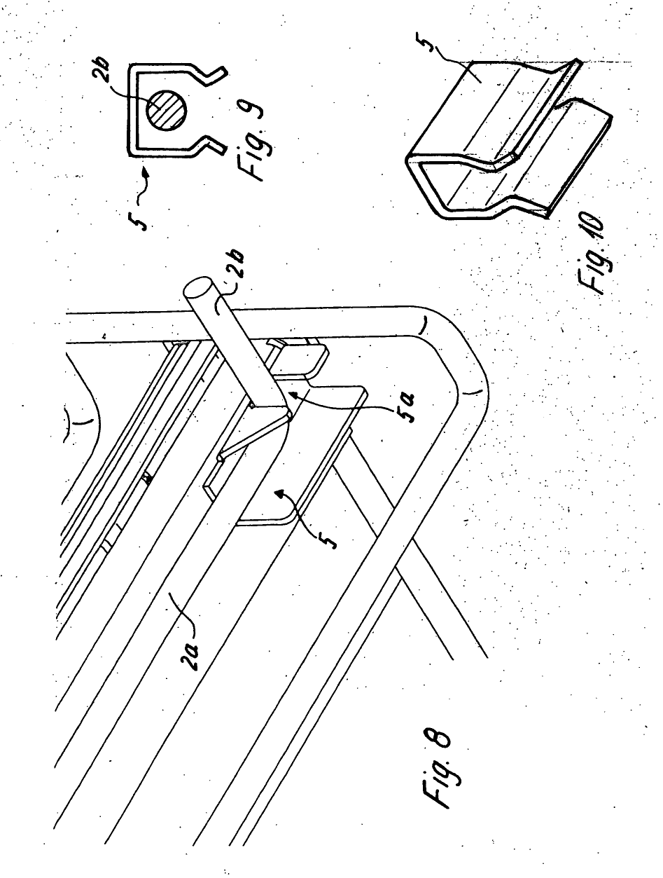

FIGS. 4a to 4d show that the forward holders have a U-shaped cross-section and are provided with a recess 5a in the area of one side leg. As illustrated in FIG. 8, an end piece 2b of the supporting rods, which is bent away transversely to the longitudinal direction of the supporting rods 2a, engages in this recess 5a so that a protection is obtained against the displacement of the guiding rail 3a in the longitudinal direction of the supporting rods 2a. This protection against a displacement can be removed by lifting the support tray 1 with the guiding devices 3 fastened thereto is lifted so far in its forward area that the end pieces 2b of the supporting rods 2a disengage from the recesses 5a.

The design of the rearward holding devices 4 illustrated in FIGS. 5a to 5d demonstrates that these rearward holding devices 4 are provided with two U-shaped sections 4a and 4b arranged offset with respect to one another in the longitudinal direction. The sections 4a and 4b are arranged offset with respect to one another by 90°. This results in the fact that a supporting rod 2a is completely enclosed by these rearward holding devices 4. A lifting of the guiding rail 3a off the used supporting rods 2a can therefore not take place.

Although, as a result of relatively generously dimensioned tolerances, a lifting of the support tray 1 and thus also of the guiding rail 3a in the forward area cannot take place until the forward holders 5 are released relative to the end pieces 2b. If, in contrast, for example, when the support tray 1 is pulled out, and is pressed downward, by a weight, the rearward end area of the guiding rails 3a cannot be lifted or tipped because of the enclosure of the supporting rods 2a by the rearward holding devices 4.

Nevertheless, by means of the described constructions, an unproblematic pushing of the guiding devices 3 onto the supporting rods 2a can take place just as well as an unproblematic removal of the guiding devices 3 from the supporting rods 2a. Thus, the handling in the practical every-day operation is considerably facilitated and simplified, with a maximum of safety during the use since the danger of an unintentional separation of the guiding devices 3 from the supporting rods 2a—as described above—is virtually prevented.

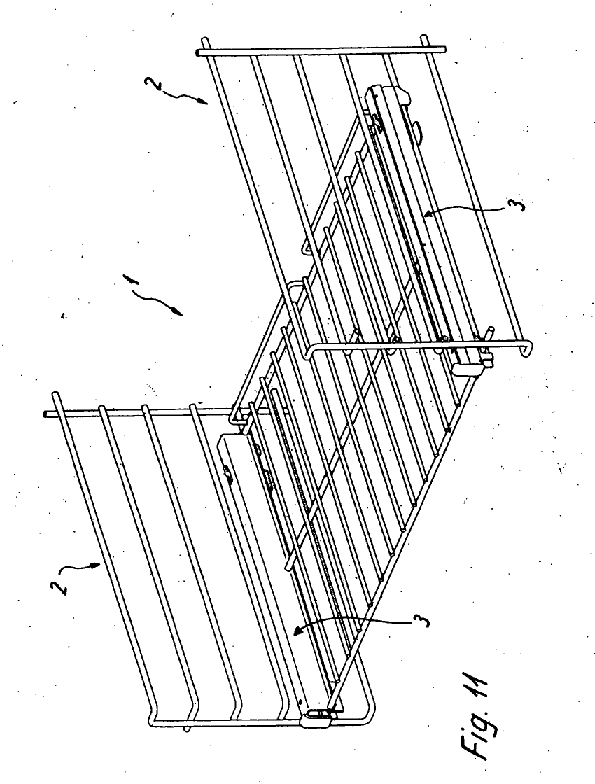

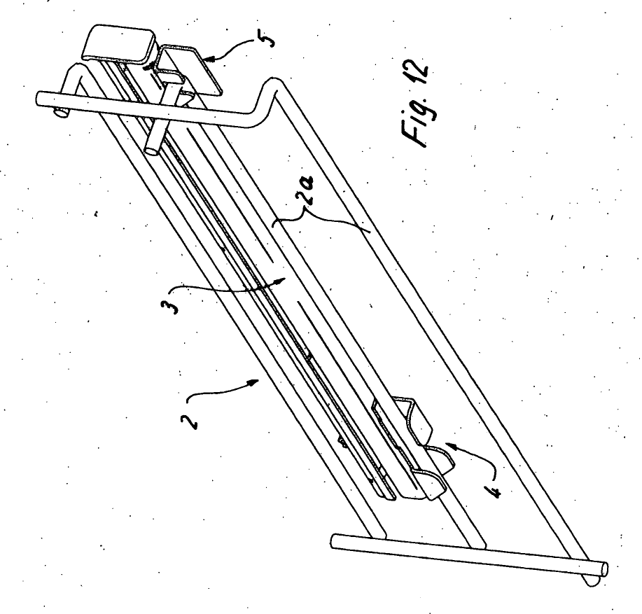

FIGS. 9 and 10 show that the forward holders 5 can also be constructed in the form of resilient clamps which, by means of a defined force, can be snapped upon the end pieces 2b or also separated again from the latter.

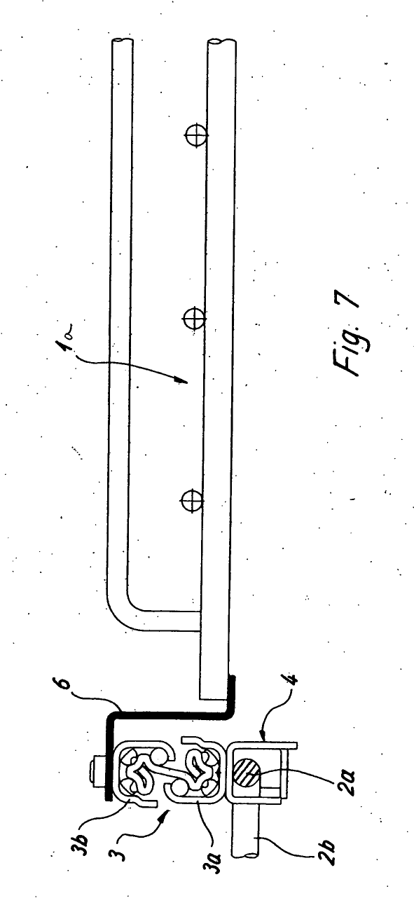

FIG. 7 shows that, for the connection between the running rail 3b of the guiding devices 3 and the tray 1a, an angle profile 6 can be used which can be welded to the tray 1a as well as to the running rails 3b. However, it is also conceivable to connect the angle profile 6 with the running rails 3b by a detachable connection, such as a screwed connection.

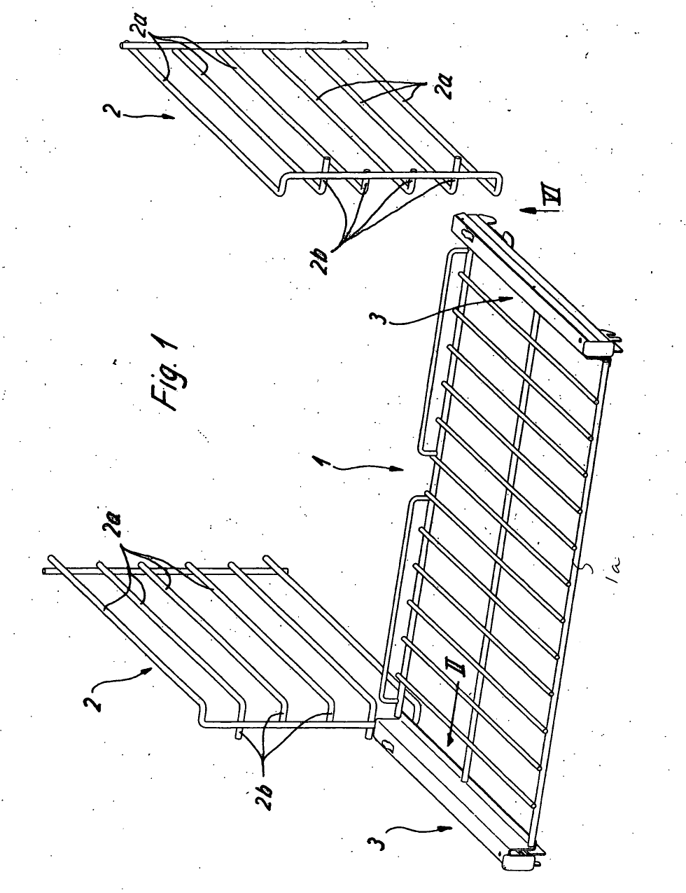

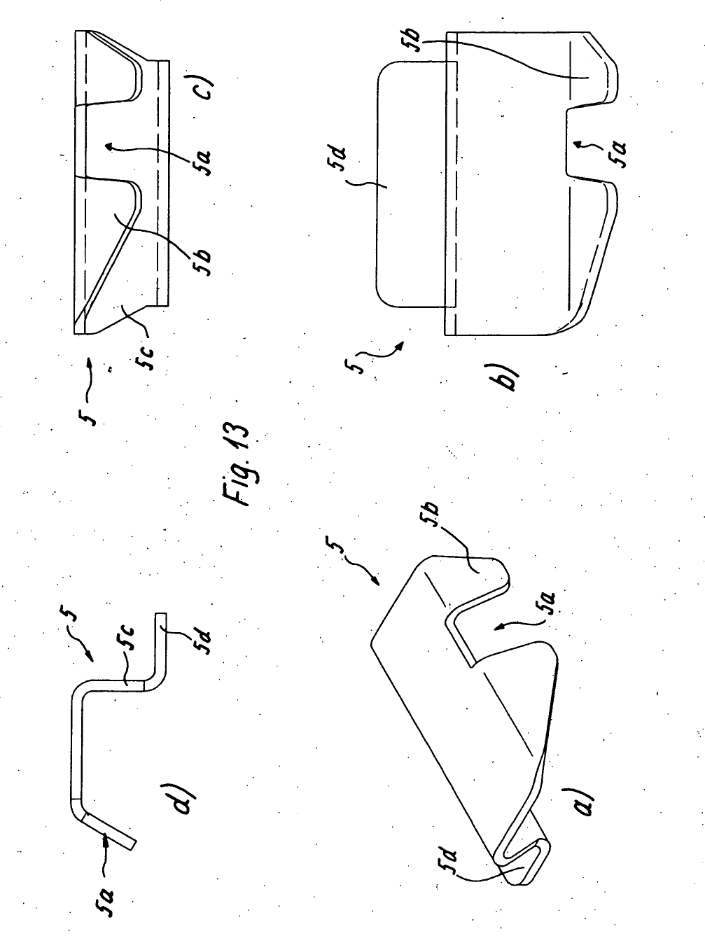

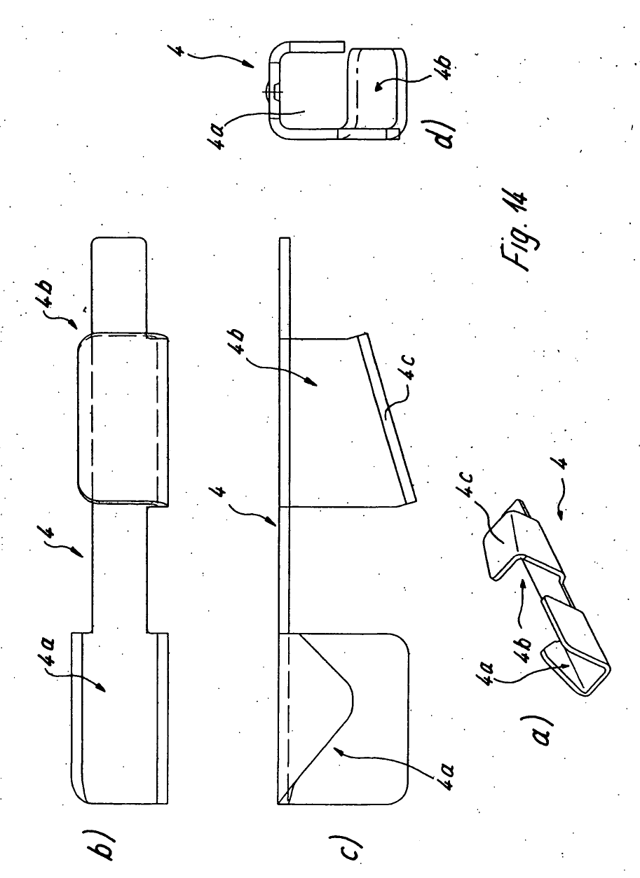

FIGS. 13a to 13d show another embodiment of the design of a forward holder 5. As in the case of the above-described embodiment, the holder 5, according to FIGS. 13a to 13b, is provided with a recess 5a to receive an end piece 2b, which is bent with respect to the longitudinal direction of the supporting rods 2a, in order to prevent a longitudinal displacement. Deviating from the described embodiments of FIG. 1, however, here the recess 5a is in a leg 5b which is bent away at a diagonal angle toward the outside. This web 5b bent away to the outside at an angle reduces the lateral play to the interior wall of a kitchen appliance.

A gripping web 5d is molded to the inner leg 5c facing the tray 1a, which gripping web 5d facilitates the gripping of the forward holder 5 for the purpose of lifting the support tray 1.

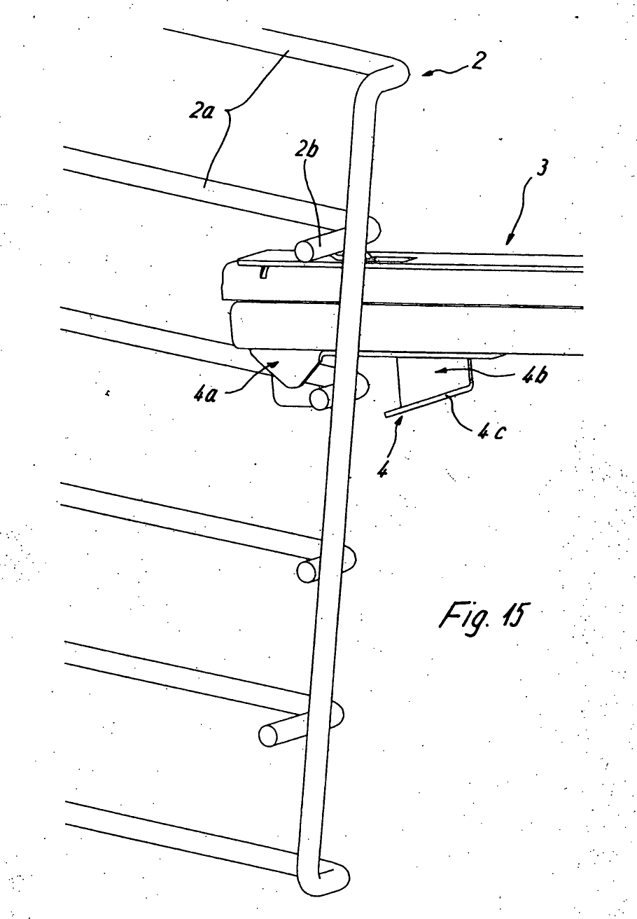

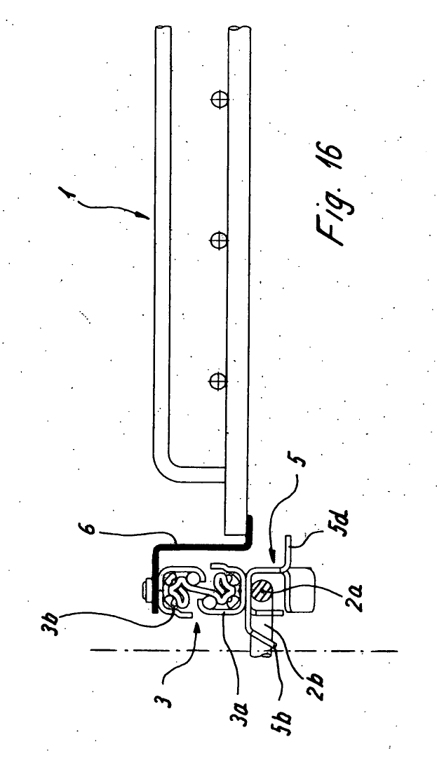

The rearward holding device 4 according to FIGS. 14a to 14d differs from the embodiments of FIG. 5 in that the gripping leg 4c of a U-shaped area 4b is designed diagonally sloping to the rear side, whereby the application of the rearward holding devices 4 to the supporting rods 2a and the insertion of the supporting rods 2a into these rearward holding devices 4 is facilitated.

If a use in a baking oven or the like is intended, the tray 1a, the guiding devices 3 and the holding devices 4 as well as the holders 5 are made of metal in order to ensure a sufficient heat resistance. However, if a support tray 1 is intended, for example, for a use in a refrigerator, all above-mentioned parts may be made of a plastic material.

Although the present disclosure has been described and illustrated in detail, it is to be clearly understood that this is done by way of illustration and example only and is not to be taken by way of limitation. The scope of the present disclosure is to be limited only by the terms of the appended claims.

1. A support tray for a kitchen appliance, such as a baking oven, a refrigerator, a microwave oven or the like, the support tray comprising:
a rectangular tray;
guiding devices at each mutually opposite lateral edges of the tray having a running rail connected to the tray and a guiding rail for mounting the support tray to support rods of a supporting grids in the side wall areas of the kitchen appliance;
the guide rail being configured to be coupled and secured, in a rearward end area, against a lifting-off from the supporting rods when coupled thereto and to be form-lockingly secured, in a forward end area, against a displacement in the longitudinal direction of the supporting rods.

2. The support tray according to claim 1, wherein for securing the guiding rail against a lifting-off from the supporting rods the guiding rail, the guiding rail includes a holding device in the rearward end area; and
the holding device has two U-shaped areas which are arranged to be offset with respect to one another by 90°, so that these U-shaped areas can reach around a supporting rod on all sides.

3. The support tray according to claim 2, wherein a leg of a U-shaped area for reaching under a supporting rod slopes in the direction of a rear side of the tray.

4. The support tray according to claim 2, wherein for securing the guiding rails against a displacement in the longitudinal direction of the supporting rods, the guiding rail includes a holder in the forward area of the guiding rails; and
the holder has a U-shaped cross-section which can reach over the supporting rods from above, and a recess in an outer leg of the holder for receiving an end area of the supporting rods which is bent away at an angle with respect to a longitudinal dimension of the supporting rods.

5. The support tray according to claim 4, wherein the leg with the recess is sloped pointing away from the tray.

6. The support tray according to claim 4, including an operating web bent away at an angle in the direction of the tray and extending from a side leg of the holder which faces the tray.

7. The support tray according to claim 1, wherein for securing the guiding rails against a displacement in the longitudinal direction of the supporting rods, the guiding rail includes a clamp-type holder which, in a spring-type manner, can be snapped onto a forward end area bent-away at an angle with respect to the supporting rod.

8. The support tray according to claim 1, wherein the tray is in the shape of a grid grating.

9. The support tray according to claim 1, wherein the support tray is constructed as a component which is closed with respect to the surface.

10. The support tray according to claim 1, wherein the tray and the guiding devices are made of metal.

11. The support tray according to claim 1, wherein the support tray and the guiding devices are made of a plastic material or of a combination of a plastic material and metal.

12. The support tray according to one claim 1, wherein the support is connected by angle sections with the running rails of the guiding devices.

13. The support tray according to claim 12, wherein the tray is un-detachably connected with the running rails by the angle sections.

14. The support tray according to claim 12, wherein the support tray is detachably connected with the running rails by the angle sections and a screwed connections.

15. The support tray according to claim 1, wherein the guiding devices includes at least one transition member telescopically connecting guiding rail and the running rails.

16. The support tray according to claim 1, wherein for securing the guiding rails against a displacement in the longitudinal direction of the supporting rods, the guiding rail includes a holder in the forward area of the guiding rails; and
the holder has a U-shaped cross-section which can reach over the supporting rods from above, and a recess in an outer leg of the holder for receiving an end area of the supporting rods which is bent away at an angle with respect to a longitudinal dimension of the supporting rods.

17. The support tray according to claim 16, wherein the leg with the recess is sloped pointing away from the tray.

18. The support tray according to claim 16, including an operating web bent away at an angle in the direction of the tray and extending from a side leg of the holder which faces the tray.
